(19) United States
(12) Patent Application Publication
(10) Pub. No.: US 2024/0144410 A1
(43) Pub. Date: May 2, 2024

(54) DEVICE, SYSTEM, AND METHOD FOR AUTOMATICALLY REPLYING TO TEXT MESSAGES

(71) Applicant: MOTOROLA SOLUTIONS, INC., Chicago, IL (US)

(72) Inventors: Jin Hoe PHUA, Bayan Lepas (MY); Tejeash DURAIMANICKAM, Lunas (MY); Carmen Jia Yi SIAU, Kota Kinabalu (MY)

(21) Appl. No.: 17/978,572

(22) Filed: Nov. 1, 2022

(51) Int. Cl. G06Q 50/26; H04W 4/12; H04W 4/90

(52) U.S. Cl. CPC G06Q 50/265; H04W 4/12; H04W 4/90

(57) ABSTRACT

Device, system and method for automatically replying to public-safety or enterprise-safety text messages is provided. A device receives, from a communication device, a text message indicative of: a given public-safety or enterprise-safety incident type; data documenting the given public-safety or enterprise-safety incident type; and a requested public-safety or enterprise-safety action associated with the given public-safety or enterprise-safety incident type. The device determines an implementable public-safety or enterprise-safety action for the given public-safety or enterprise-safety incident type based on the data. In response to determining, at the device, a difference between the requested public-safety or enterprise-safety action and the implementable public-safety or enterprise-safety action, the device: generates a reply text message identifying one or more of the implementable public-safety or enterprise-safety action and the difference; and transmits, to the communication device, the reply text message.

### BACKGROUND OF THE INVENTION

In emergency services environments, text messages may often be received demanding actions in response to public-safety or enterprise-safety incidents.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for automatically replying to public-safety or enterprise-safety text messages, in accordance with some examples.

FIG. 2 is a device diagram showing a device structure of a computing device for automatically replying to public-safety or enterprise-safety text messages, in accordance with some examples.

FIG. 3 is a flowchart of a method for automatically replying to public-safety or enterprise-safety text messages, in accordance with some examples.

FIG. 4 depicts aspects of a method for automatically replying to public-safety or enterprise-safety text messages being implemented by the system of FIG. 1, in accordance with some examples.

FIG. 5 depicts further aspects of a method for automatically replying to public-safety or enterprise-safety text messages being implemented by the system of FIG. 1, in accordance with some examples.

FIG. 6 depicts yet further aspects of a method for automatically replying to public-safety or enterprise-safety text messages being implemented the system of FIG. 1, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In emergency services environments, text messages may often be received demanding actions in response to public-safety or enterprise-safety incidents that a sender of a text message may have witnessed. However, there may be criteria for responding to a public-safety or enterprise-safety incident, which may or may not be met by a text message demanding an action for the public-safety or enterprise-safety incident. Thus, there exists a need for an improved technical method, device, and system for automatically replying to public-safety or enterprise-safety text messages that demand and/or request actions for public-safety or enterprise-safety incidents.

Hence, provided herein is a device, system and method for automatically replying to public-safety or enterprise-safety text messages. For example, a system is provided that includes a computing device that may receive text messages on behalf of a public-safety answering point (PSAP), and automatically responds to the text messages. In some examples, the PSAP may be to manage public-safety or enterprise-safety incidents. For example, public-safety or enterprise-safety incident may include, but is not limited to, a police incident, a fire incident, a medical incident, a mental health incident, and the like, which may occur in a public space or an enterprise space (e.g. at a business), and/or a security guard incident, and the like, which may occur which may occur in a public space or an enterprise space managed by a private enterprise. However, responders to a public-safety or enterprise-safety incident may be public-safety officers employed, for example, by a public-safety agency, or enterprise-safety officers employed, for example, by a private enterprise; examples of enterprise-safety officers may include, but are not limited to, security guards, mental health professionals (e.g. associated with a mental-wellness agency), and the like.

While hereafter reference is made to public-safety incidents, PSAPs, text messages to 911 (and the like), public-safety actions, and the like, it is understood that any incidents, answering points, texts and/or action referred to herein may alternatively, or in addition, include enterprise-safety incidents, enterprise-safety answering points (e.g. an emergency services answering point, such as a security guard answering point and/or station at a mall or business), enterprise-safety text messages to (e.g. to an emergency services number managed by a business), enterprise-safety actions, and the like.

The provided computing device that may receive text messages on behalf of a PSAP (and the like) may comprise a proxy for the PSAP, for example to relieve the PSAP of responding to text messages, which may save bandwidth and processing resources at the PSAP. For example, a user of a communication device may send a text message to “911”, and/or another emergency services number, to report a public-safety or enterprise-safety incident and request (and/or demand) that an action occur in response to the public-safety or enterprise-safety incident, and the text message may be received at the computing device rather than the PSAP.

Such text messages may be indicative of: a given public-safety or enterprise-safety incident type; data documenting the given public-safety or enterprise-safety incident type; and a requested public-safety or enterprise-safety action associated with the given public-safety or enterprise-safety incident type. However, such information may be provided in plain and/or natural language; for example, the text message may not be specifically structured in a manner that separates indications of a given public-safety or enterprise-safety incident type, data documenting the given public-safety or enterprise-safety incident type, and a requested public-safety or enterprise-safety action associated with the given public-safety or enterprise-safety incident type. Indeed, in some examples, information in the text message that indicates the given public-safety or enterprise-safety incident type and/or the data documenting the given public-safety or enterprise-safety incident type and/or the requested public-safety or enterprise-safety action associated with the given public-safety or enterprise-safety incident type may be implied and/or indirectly provided in the text message.

The computing device may hence, in some examples, implement a context engine and/or a natural language processing (NLP) engine that may process the text message to determine the given public-safety or enterprise-safety incident type and/or the data documenting the given public-safety or enterprise-safety incident type and/or the requested public-safety or enterprise-safety action associated with the given public-safety or enterprise-safety incident type.

The computing device may determine an implementable public-safety or enterprise-safety action for the given public-safety or enterprise-safety incident type based on the given public-safety or enterprise-safety incident type indicated by the text message. Such a determination may occur using a database lookup and/or one or more machine learning algorithms, and the like. Regardless, the implementable public-safety or enterprise-safety action may comprise an action to be taken by public-safety personnel or enterprise-safety personnel, and the like, and may be defined by statutory regulations and/or protocol and/or criteria local to where the public-safety or enterprise-safety incident has occurred and/or a location of the communication device, from which the text message was received. Furthermore, different implementable public-safety or enterprise-safety actions may be associated with different documentation as described herein, for example as defined by the statutory regulations and/or protocol and/or criteria. Furthermore, an implementable public-safety or enterprise-safety action that may be determined may be the same as, or different from, a requested public-safety or enterprise-safety action indicated by the text message.

The computing device may determine whether there is a difference between the requested public-safety or enterprise-safety action and the implementable public-safety or enterprise-safety action and, in response to determining such a difference, the computing device may generate and transmit a reply text message to the communication device that identifies the implementable public-safety or enterprise-safety action and/or the difference.

In a specific example, a text message may be received at the computing device, from a communication device, that indicates that a stranger has been observed walking around a neighborhood (e.g. or a business), for example by a user of the communication device, and the text message may further request that the stranger be arrested and/or that police be sent immediately. The computing device may analyze the text message, for example, using the context engine and/or NLP engine, and the like, to determine that: the given public-safety or enterprise-safety incident type comprises “Loitering”; the data documenting the given public-safety or enterprise-safety incident type merely comprises a textual report of the stranger; and a requested public-safety or enterprise-safety action associated with the given public-safety or enterprise-safety incident type comprises “Dispatch Patrol Car Immediately”, for example to send police to the location of the loitering (e.g., which may be received with the text message as metadata), to investigate and/or arrest the stranger.

However, the computing device may determine that when a report of a stranger loitering is received, an implementable public-safety or enterprise-safety action is to investigate using a patrol car that is not dispatched immediately, but may investigate when the patrol car reaches a location of the observed loitering in a routine and/or predetermined patrol schedule. In particular, such an implementable public-safety or enterprise-safety action may comprise “Routine Patrol Car Only”.

As such, the computing device may determine a difference between a requested public-safety or enterprise-safety action (e.g., “Dispatch Patrol Car Immediately”) and an implementable public-safety or enterprise-safety action (e.g., “Routine Patrol Car Only”) and, in response, generate a reply text message identifying one or more of the implementable public-safety or enterprise-safety action and the difference. The computing device may transmit the text message to the communication device.

Using the above example, the reply text message may indicate that a “Routine Patrol Car” will investigate and no patrol car will be dispatched immediately.

The computing device may further initiate the implementable public-safety or enterprise-safety action, for example by transmitting the report of a stranger and the associated location to a suitable communication device and/or radio operated by police officer associated with the patrol car that may routinely investigate and/or by communicating the report of a stranger and the associated location to the PSAP, which may transmit the report of a stranger and the associated location to the communication device and/or radio operated by the police officer associated with the patrol car.

In some instances, the computing device may determine further data required for implementing the requested public-safety or enterprise-safety action, and include, in the reply text message an indication of the further data.

For example, again using the above example, an implementable public-safety or enterprise-safety action of “Dispatch Patrol Car Immediately” may occur when a photo of the stranger is received (e.g., according to the aforementioned statutory regulations and/or protocol and/or criteria). In these examples, the reply text message may indicate that the requested public-safety or enterprise-safety action may be implemented when a photo of the stranger is received. In some examples, the communication device may receive the reply text message and, in response, the communication device may be operated to send such a photo to the computing device, and the computing device may change the previous implementable public-safety or enterprise-safety action (e.g., “Routine Patrol Car Only”) to the requested public-safety or enterprise-safety action (e.g., “Dispatch Patrol Car Immediately”), which may occur via communication with the communication device and/or radio operated by the police officer associated with the patrol car being dispatched and/or the PSAP. The computing device may transmit a further reply text message to the communication device indicating the change in action.

While “Dispatch Patrol Car Immediately” and “Routine Patrol Car Only” are examples of public-safety actions, enterprise-safety actions, such as “Routine Security Guard Check” and “Dispatch Security Guard Immediately” and “Dispatch Mental Health Personnel”, amongst other possibilities, are within the scope of the present specification.

A first aspect of the present specification provides a method comprising: receiving, at a computing device, from a communication device, a text message indicative of: a given public-safety or enterprise-safety incident type; data documenting the given public-safety or enterprise-safety incident type; and a requested public-safety or enterprise-safety action associated with the given public-safety or enterprise-safety incident type; determining, at the computing device, an implementable public-safety or enterprise-safety action for the given public-safety or enterprise-safety incident type based on the data; and in response to determining, at the computing device, a difference between the requested public-safety or enterprise-safety action and the implementable public-safety or enterprise-safety action: generating, at the computing device, a reply text message identifying one or more of the implementable public-safety or enterprise-safety action and the difference; and transmitting, from the computing device, to the communication device, the reply text message.

A second aspect of the present specification provides a device comprising: a communication interface; and a controller configured to: receive, via the communication interface, from a communication device, a text message indicative of: a given public-safety or enterprise-safety incident type; data documenting the given public-safety or enterprise-safety incident type; and a requested public-safety or enterprise-safety action associated with the given public-safety or enterprise-safety incident type; determine an implementable public-safety or enterprise-safety action for the given public-safety or enterprise-safety incident type based on the data; and in response to determining a difference between the requested public-safety or enterprise-safety action and the implementable public-safety or enterprise-safety action: generate a reply text message identifying one or more of the implementable public-safety or enterprise-safety action and the difference; and transmit, via the communication interface, to the communication device, the reply text message.

Each of the above-mentioned aspects will be discussed in more detail below, starting with example system and device architectures of the system, in which the embodiments may be practiced, followed by an illustration of processing blocks for achieving an improved technical method, device, and system for automatically replying to public-safety or enterprise-safety text messages.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Herein, the term “engine”, such as a context engine, a natural language processing engine, is understood to refer to hardware, and/or a combination of hardware and software (e.g., a combination of hardware and software includes software hosted at hardware, such as a software module that is stored at a processor-readable memory implemented or interpreted by a processor), or hardware and software hosted at hardware and/or implemented as a system-on-chip architecture and the like.

Further advantages and features consistent with this disclosure will be set forth in the following detailed description, with reference to the drawings.

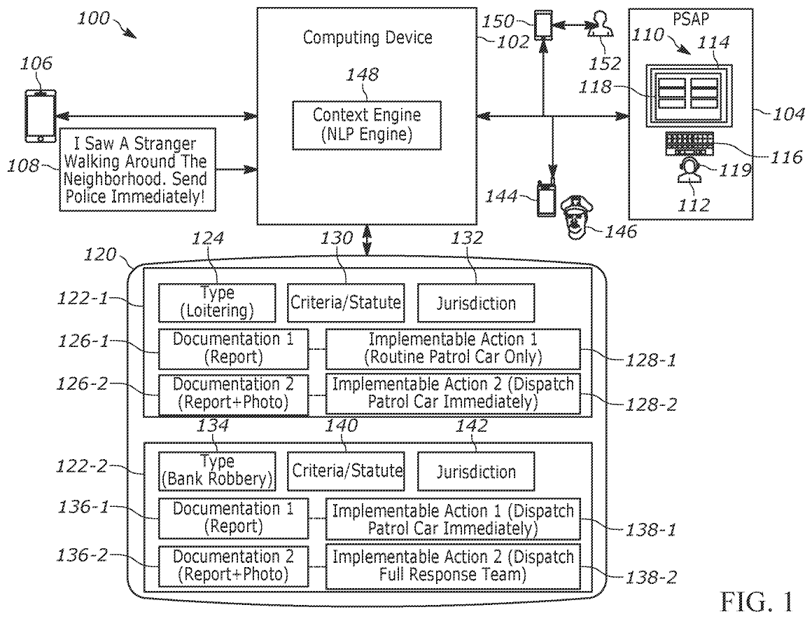

Attention is directed to FIG. 1, which depicts an example system 100 for automatically replying to public-safety or enterprise-safety text messages. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a computing device 102, which may generally be configured as a text message-handling device for at least one PSAP 104. The computing device 102 may comprise any suitable combination of one or more servers, one or more cloud computing devices, one or more proxy devices, and the like. While only the PSAP 104 is depicted, the system 100 may alternatively, or in addition, include an enterprise-safety answering point operated by a private enterprise, which may handle calls and/or texts to an associated emergency services telephone number (e.g. associated with the private enterprise), and the like, such as a telephone number of a security guard station, and the like. However, the PSAP 104 may be configured to receive calls and/or text from such a telephone number (e.g. in addition to “911” calls, described herein).

While only one PSAP 104 is depicted, the computing device 102 may be configured as a text message-handling device for a plurality of PSAPs, for example for different jurisdictions and/or locations.

As depicted, the computing device 102 may be configured to communicate with a communication device 106 to receive a text message 108, for example as a proxy for the PSAP 104. For example, the text message 108 may be texted to “911”, and the like, which is received at the computing device 102. In particular, the computing device 102 may be configured to receive 911 texts from an area where the communication device 106 is initiating the text message 108, and/or which may be part of a jurisdiction that is managed by the PSAP 104.

As depicted, the text message 108 includes text “I saw a stranger walking around the neighborhood. Send police immediately!”. It is understood that the text message 108 is reporting a public-safety or enterprise-safety incident, for example loitering by the indicated stranger, and/or a potential public-safety or enterprise-safety incident as the stranger may not actually be loitering. Hereafter, a public-safety or enterprise-safety incident is interchangeably referred to as a public-safety incident.

In other examples, the text message 108 may include but is not limited to, a photo, an audio file, a video file, and the like, for example in a body of the text message 108 and/or as an attachment to the text message 108, and the like. The text message 108 may hence include any suitable type of text message including, but not limited to, an SMS (Short Message Service) message, an MMS (Multimedia Messaging Service) message, and the like. Put another way, a “text message” as described herein may include text and any other suitable type of multimedia, and the like.

The computing device 102 may receive an associated location with the text message 108, for example as metadata, and the associated location may comprise a location of the communication device 106, for example as determined by a location determining device (e.g., and determined by a Global Positioning System (GPS) device of the communication device 106, and/or by network components, on which the text message 108 is being communicated, for example using triangulation techniques, and/or using any other suitable network components, and the like).

However, the computing device 102 may receive an associated location of the public-safety incident being reported by the text message 108 in the body of the text message 108, which may be different from a location of the communication device 106. For example, a user of the communication device 106 may notice a public-safety incident occurring, but may be moving (e.g., as walking, running, or in a vehicle), and the user of the communication device 106 may report the public-safety incident via the text message 108 from a location that is different from the location of the communication device 106. For example, the text message 108 may comprise “I saw a stranger walking around the neighborhood near 123 Main Street. Send police immediately!”; in these examples, an associated location of the public-safety incident may comprise “123 Main Street”.

As depicted, the PSAP 104 may include a PSAP terminal 110, which be operated by an operator 112, and the PSAP terminal 110 may comprise a display screen 114 and an input device 116 (e.g., as such a keyboard, as depicted, a pointing device and/or any other suitable input device). However, the display screen 114 and the input device 116 may be provided in any suitable format (e.g., different from a PSAP terminal), such as a laptop, a personal computer, and the like (e.g., when the operator 112 is working from home and/or “off-premises” from the PSAP 104). In general, the display screen 114 and the input device 116 may be used to interact with the PSAP terminal 110, for example via an interface 118 provided at the display screen 114, and the like. The PSAP terminal 110 further comprise a communication device, for example as represented in FIG. 1 by a headset 119 worn by the operator 112.

As depicted, the computing device 102 is further in communication with a memory 120, which may be provided in the form of a database, and the like. The memory 120 may be separate from the computing device 102 (e.g., as depicted) and/or the memory 120 may be at least partially integrated with the computing device 102.

The memory 120 stores records 122-1, 122-2, and the like, associated with different respective public-safety or enterprise-safety incident types. The records 122-1, 122-2 are interchangeably referred to hereafter, collectively, as the records 122 and, generically, as a record 122. This convention will be used elsewhere in the present specification.

While for simplicity, two records 122 are depicted, the memory 120 may store any suitable number of records 122, for example a record 122 per public-safety or enterprise-safety incident type, a record 122 per public-safety or enterprise-safety incident type for each jurisdiction and/or area that the computing device 102 may service, and/or any other suitable number.

As depicted, the record 122-1 comprises indications of:
A type 124 of an associated public-safety (or enterprise-safety incident). For example, the record 122-1 is associated with a public-safety or enterprise-safety incident type of “Loitering”.
Documentation 126-1, 126-2 (e.g., sets of documentation 126 and/or a set of documentation 126) associated with respective implementable public-safety or enterprise-safety actions 128-1, 128-2 (e.g., implementable public-safety or enterprise-safety actions 128 and/or an implementable public-safety or enterprise-safety action 128). For example, for the implementable public-safety or enterprise-safety action 128-1 of “Routine Patrol Car Only” to occur, respective documentation 126-1 of a report (e.g., of loitering) should be received. However, for the implementable public-safety or enterprise-safety action 128-2 of “Dispatch Patrol Car Immediately” to occur, respective documentation 126-1 of a “Report” (e.g., of loitering) and a “Photo” (e.g., of the person loitering) should be received. Furthermore, while two sets of documentation 126 and associated implementable public-safety or enterprise-safety actions 128 are depicted, any suitable number of sets of documentation 126 and associated implementable public-safety or enterprise-safety actions 128 are within the scope of the present specification. Furthermore, while the depicted example documentation 126-2 includes reference to a “Photo”, such a “Photo” may include video and the like. Furthermore, while the depicted example documentation 126-2 includes reference to a “Photo”, other documentation 126 may make specify other types of multimedia, such as video and/or audio.
Criteria and/or a statute 130 (hereafter interchangeable referred to as a statute 130) that may define the documentation 126 associated with the implementable public-safety or enterprise-safety actions 128; for example the statute 130 may comprise one or more of statutory regulations (e.g., a law) and a protocol (e.g., criteria and/or a policy) defined by a jurisdiction, that defines a type of documentation 126 required to perform an associated implementable public-safety or enterprise-safety action 128. While the documentation 126 and associated implementable public-safety or enterprise-safety actions 128 may be populated on the basis of the statute 130, the information stored in the statute 130 may comprise text reciting a section of one or more of statutory regulations and a protocol, for example in natural language and/or as set out by law makers and/or policy makers, and the like. The statute 130 may, however, be optional in the record 122-1.
A jurisdiction 132 associated with the statute 130. For example, the jurisdiction 132 may define an area, in which the statute 130 applies, and the like, which may be a same area serviced by the PSAP 104.

The record 122-1 may comprise any other suitable information.

Similarly, the record 122-2 comprises respective indications of a respective type 134 of public-safety incident, respective documentation 136-1, 136-1 (e.g., sets of documentation 136 and/or a set of documentation 136) associated with respective implementable public-safety or enterprise-safety actions 138-1, 138-2 (e.g., implementable public-safety or enterprise-safety actions 138 and/or an implementable public-safety or enterprise-safety action 138) and, optionally, a respective criteria and/or a statute 140 (hereafter interchangeable referred to as a statute 140) associated with a respective jurisdiction 142.

For example, as depicted, the record 122-2 is associated with a type 124 of a public-safety incident of a “Bank Robbery”, and for the implementable public-safety or enterprise-safety action 138-1 of “Dispatch Patrol Car Immediately” to occur, documentation 136-1 of a “Report” (e.g., of a bank robbery) should be received, whereas for the implementable public-safety or enterprise-safety action 138-2 of “Dispatch Full Response Team” to occur, documentation 136-2 of a “Report” and a “Photo” of the bank robbery should be received.

In some examples, the jurisdictions 132, 142 may be the same, while in other examples the jurisdictions 132, 142 may be different.

Furthermore, the statutes 130, 140 may be particular to text messages, and define what types of documentation 126, 136 should be received in text messages for an associated implementable public-safety or enterprise-safety action 128, 138 to occur. Alternatively, the statutes 130, 140 may be generic, and define what types of documentation 126, 136 should be received at a PSAP (e.g., the PSAP 104), in any suitable manner, for an associated implementable public-safety or enterprise-safety action 128, 138 to occur.

As depicted, the system 100 optionally comprises a radio 144 that may be operated by a public-safety officer 146, for example, as depicted, a police officer who may be on patrol (e.g., in a patrol car). While the radio 144 is depicted as a hand-held radio, the radio 144 may comprise any suitable communication device that may be operated by public-safety personnel, including, but not limited to, a patrol car radio, a radio having a cell-phone configuration, and the like.

As depicted, the radio 144 is configured to communicate with the computing device 102 and the PSAP 104. However, in other examples, the radio 144 may be configured to communicate with the PSAP 104 via the computing device 102, or the radio 144 may be configured to communicate with the computing device 102 via the PSAP 104.

Returning to the computing device 102 and the text message 108, the text message 108 is generally indicative of a given public-safety or enterprise-safety incident type; data documenting the given public-safety or enterprise-safety incident type; and a requested public-safety or enterprise-safety action associated with the given public-safety or enterprise-safety incident type. For example, the text message 108 may indicate that: an associated given public-safety or enterprise-safety incident type is “Loitering” (e.g., by way of text “I saw a stranger walking around the neighborhood”); data documenting the given public-safety or enterprise-safety incident type is a report of the loitering (e.g., also by way of text “I saw a stranger walking around the neighborhood”, and as the text message 108 is sent without a photo); and a requested public-safety or enterprise-safety action is to “Dispatch A Patrol Car Immediately” (e.g., by way of text “Send police immediately!”).

However, the text message 108 of “I saw a stranger walking around the neighborhood. Send police immediately!” does not explicitly include the text “Loitering”; nor does the text message 108 explicitly include the text “Report”; and nor does the text message 108 explicitly include the text “Dispatch A Patrol Car Immediately”.

As such, the computing device 102 may comprise (e.g., and/or implement) a context engine and/or NLP engine 148 (interchangeably referred to hereafter as the context engine 148) configured to analyze the text message 108 to more explicitly determine one or more of: the given public-safety or enterprise-safety incident type; the data documenting the given public-safety or enterprise-safety incident type; and the requested public-safety or enterprise-safety action associated with the given public-safety or enterprise-safety incident type, for example in a format that is compatible with the records 122. Implementation of the context engine 148 is described in more detail below. However, the functionality of the context engine 148 may be implemented in any suitable manner at the computing device 102, including, but not limited to, using one or more machine learning algorithms, which may be a component of the context engine 148, and/or may be provided separately from the context engine 148. In yet another alternative, the functionality of the context engine 148 may be implemented via one or more numerical algorithms, which may be a component of the context engine 148, and/or may be provided separately from the context engine 148. Hence, the context engine 148 may be optional.

The computing device 102 may be generally configured to determine (e.g., using the context engine 148, one or more machine learning algorithms, and the like), from the text message 108: a given public-safety or enterprise-safety incident type; data documenting the given public-safety or enterprise-safety incident type; and a requested public-safety or enterprise-safety action associated with the given public-safety or enterprise-safety incident type. For example, the computing device 102 may determine from the text message 108 that a given public-safety or enterprise-safety incident type indicated by the text message 108 is “Loitering” and that the data documenting the given public-safety or enterprise-safety incident type from the text message 108 is a “Report” of the “Loitering” (e.g., without a photo), and that a requested public-safety or enterprise-safety action is “Dispatch Patrol Car Immediately”.

The computing device 102 may further determine an implementable public-safety or enterprise-safety action for the given public-safety or enterprise-safety incident type based on the data. For example, the computing device 102 may determine from the text message 108 that a given public-safety or enterprise-safety incident type indicated by the text message 108 is “Loitering” and that the data documenting the given public-safety or enterprise-safety incident type from the text message 108 is a “Report” of the “Loitering” (e.g., without a photo). As such, the computing device 102 may use the given public-safety or enterprise-safety incident type of “Loitering” to perform a database lookup of the record 122-1 at the memory 120, to determine that the data indicated by the text message 108 corresponds to the documentation 126-1 of a “Report” and hence determine the implementable public-safety or enterprise-safety action 128-1 of “Routine Patrol Car Only”.

The computing device 102 may determine that there is a difference between the requested public-safety or enterprise-safety action of “Dispatch Patrol Car Immediately” and the implementable public-safety or enterprise-safety action 128-1 of “Routine Patrol Car Only” and responsively generate a reply text message identifying one or more of the implementable public-safety or enterprise-safety action 128-1 and the difference. The computing device 102 may transmit the reply text message to the communication device 102. The computing device 102 may further cause the implementable public-safety or enterprise-safety action 128-1 of “Routine Patrol Car Only” to occur, for example by transmitting a message to the radio 144 that the loitering is to be investigated while on routine patrol; such a message may include a location received with the text message 108. Hence, the system 100 relieves the PSAP 104 of bandwidth and processing resources in responding to the text message 108 and/or causing the implementable public-safety or enterprise-safety action 128-1 to occur.

As depicted, the system 100 optionally comprises a communication device 150 that may be operated by an enterprise-safety officer 152, for example a security guard or mental health professional. While the communication device 150 is depicted as a cell phone, the communication device 150 may comprise any suitable communication device that may be operated by enterprise-safety personnel, including, but not limited to, a radio, a laptop, a terminal, and the like.

As depicted, the communication device 150 is configured to communicate with the computing device 102 and the PSAP 104. However, in other examples, the communication device 150 may be configured to communicate with the PSAP 104 via the computing device 102, or the communication device 150 may be configured to communicate with the computing device 102 via the PSAP 104. Alternatively, the communication device 150 may be configured to communicate with the communication device 106.

In some alternative examples, the actions 128 may include actions that include, but are not limited to, dispatching the enterprise-safety officer 152 to a public-safety or enterprise-safety incident, for example via the communication device 150 (e.g. similar to dispatching the public-safety officer 146 via the radio 144). In some further alternative examples, the actions 128 may include providing contact information of the enterprise-safety officer 152 to a communication device that provided a text to the computing device 102 (e.g. the text 108 provided by the communication device 106); such contact information may include, but is not limited to, a telephone number, and the like, associated with the communication device 150.

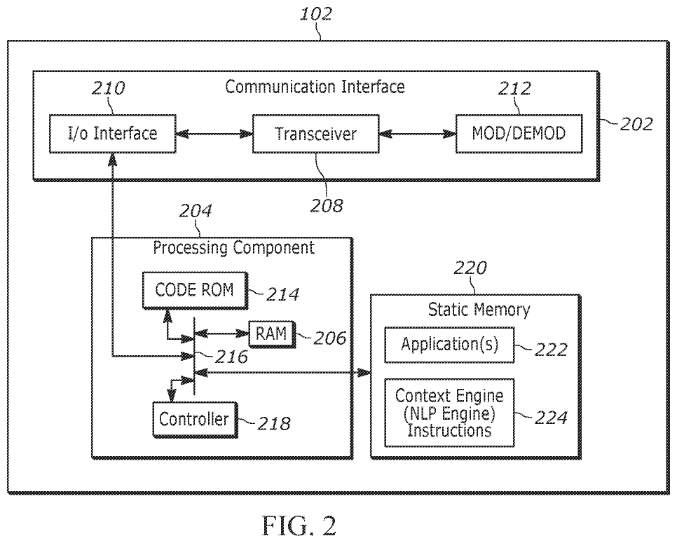

Attention is next directed to FIG. 2, which depicts a schematic block diagram of an example of the computing device 102. While the computing device 102 is depicted in FIG. 2 as a single component, functionality of the computing device 102 may be distributed among a plurality of components and the like including, but not limited to, any suitable combination of one or more servers, one or more cloud computing devices, one or more proxy devices, and the like. In some examples, a portion of the functionality of the computing device 102 may be integrated with the PSAP 104.

As depicted, the computing device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 102 may have any suitable structure and/or configuration. Furthermore, a portion of the memory 220 may comprise the memory 120.

While not depicted, the computing device 102 may include, and/or be in communication with, one or more of an input device and a display screen (and/or any other suitable notification device) and the like, such as the input device 116 and/or the display screen 114 of the PSAP terminal 110, and the like.

As shown in FIG. 2, the computing device 102 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the computing device 102 is not a generic controller and/or a generic device, but a device specifically configured to implement functionality for automatically replying to public-safety or enterprise-safety text messages. For example, in some examples, the computing device 102 and/or the controller 218 specifically comprises a computer executable engine configured to implement functionality for automatically replying to public-safety or enterprise-safety text messages.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 102 as described herein are maintained, persistently, at the memory 220 and used by the controller 218, which makes appropriate utilization of volatile storage during the execution of such programming instructions.

As depicted, the memory 220 further stores programming instructions 224 (e.g., machine readable instructions) for implementing the context engine 148. While depicted as separate from the application 222, the programming instructions 224 for implementing the context engine 148 may comprise a component of the application 222.

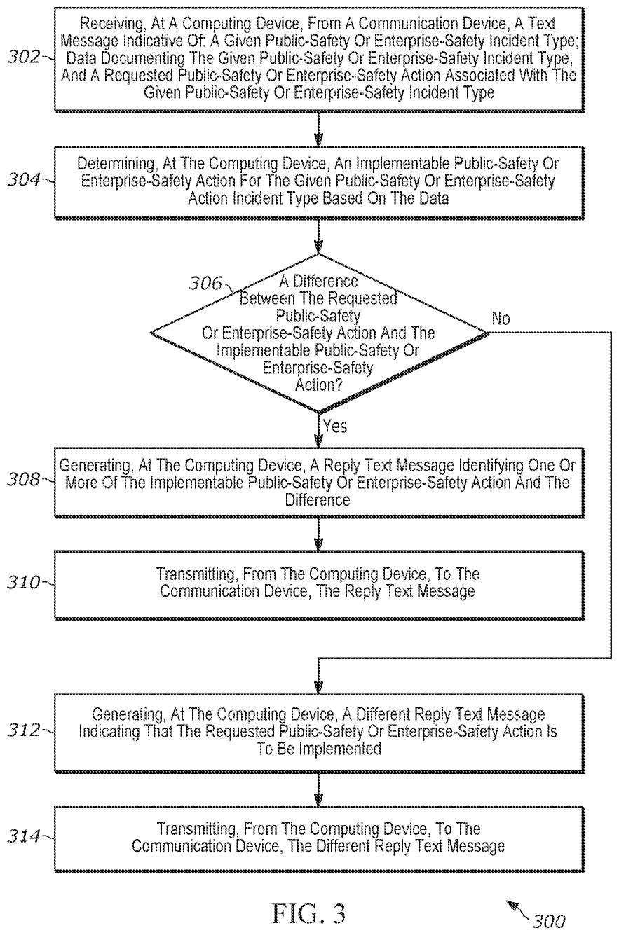

In particular, the memory 220 stores instructions corresponding to the at least one application 222 (and the programming instructions 224) that, when executed by the controller 218, enables the controller 218 to implement functionality for automatically replying to public-safety or enterprise-safety text messages, including but not limited to, the blocks of the method set forth in FIG. 3.

The application 222 and/or the programming instructions 224 may include programmatic algorithms, and the like, to implement functionality as described herein. Alternatively, and/or in addition to numerical algorithms, the application 222 and/or the programming instructions 224 may include machine learning models and/or algorithms, and the like, which have been trained to implement functionality for automatically replying to public-safety or enterprise-safety text messages. Furthermore, the application 222 and/or the programming instructions 224 may be operated in a training mode to train machine learning models and/or algorithms thereof to implement functionality for automatically replying to public-safety or enterprise-safety text messages.

The one or more machine learning models and/or algorithms of the application 222 and/or the programming instructions 224 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some public-safety environments, such as PSAP environments, and the like. Any suitable machine learning algorithm and/or deep learning algorithm and/or neural network is within the scope of present examples.

While details of the PSAP 104, the PSAP terminal 110, the communication device 106 and the radio 144 are not depicted, the PSAP 104, the PSAP terminal 110, the communication device 106 and the radio 144 may have components similar to the computing device 102 adapted, however, for the functionality thereof.

Attention is now directed to FIG. 3, which depicts a flowchart representative of a method 300 for automatically replying to public-safety or enterprise-safety text messages. The operations of the method 300 of FIG. 3 correspond to machine readable instructions that are executed by the computing device 102, and specifically the controller 218 of the computing device 102. In the illustrated example, the instructions represented by the blocks of FIG. 3 are stored at the memory 220 for example, as the application 222 and/or the programming instructions 224. The method 300 of FIG. 3 is one way that the controller 218 and/or the computing device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 218, and/or the computing device 102, receives (e.g., via the communication interface 202), from the communication device 106, the text message 108 indicative of: a given public-safety or enterprise-safety incident type; data documenting the given public-safety or enterprise-safety incident type; and a requested public-safety or enterprise-safety action associated with the given public-safety or enterprise-safety incident type. Hence, the text message 108 is understood to comprise a public-safety and/or enterprise safety text message.

In some examples, the text message 108 may explicitly recite a given public-safety or enterprise-safety incident type, for example via text such as “Loitering”, “Bank Robbery”, and the like.

Similarly, in some examples, the text message 108 may explicitly recite and/or include data documenting the given public-safety or enterprise-safety incident type, for example via text such as “Report”, and/or “Reporting” “Bank Robbery”, and the like. In other examples, the data documenting the given public-safety or enterprise-safety incident type may include photos, video, audio, and the like.

As such, the data documenting the given public-safety or enterprise-safety incident type may comprise one or more of: text of the text message 108; and attachments to the text message 108 (e.g., such as photos, audio files, video files, and the like).

Similarly, in some examples, the text message 108 may explicitly recite a requested public-safety or enterprise-safety action associated with the given public-safety or enterprise-safety incident type, for example via text such as “Dispatch Patrol Car Immediately”.

Put another way, while an example of the text message 108 is shown in FIG. 1 that uses natural language, in other examples the text message 108 may be structured in a manner that specifically and explicitly includes recitations of the given public-safety or enterprise-safety incident type, the data documenting the given public-safety or enterprise-safety incident type, and the requested public-safety or enterprise-safety action associated with the given public-safety or enterprise-safety incident type, in a predefined order and/or according to a predefined structure. One example of such a structured text message 108 may comprise: “Given Public-Safety or Enterprise-Safety Incident Type: Loitering; Documentation Data: Report Seeing Stranger; Requested Public-Safety or Enterprise-Safety Action: Dispatch Patrol Car Immediately”. In such examples, the controller 218, and/or the computing device 102 may be configured to analyze and/or process such a structured text message 108 (e.g., on the basis of a predefined structure) to determine the given public-safety or enterprise-safety incident type, the data documenting the given public-safety or enterprise-safety incident type, and the requested public-safety or enterprise-safety action associated with the given public-safety or enterprise-safety incident type. Such analyzing and/or processing may occur without use of the context engine 148.

In other examples, the given public-safety or enterprise-safety incident type, the data documenting the given public-safety or enterprise-safety incident type, and the requested public-safety or enterprise-safety action associated with the given public-safety or enterprise-safety incident type may be explicitly recited in the text message 108, but may not be strictly provided in a predefined structure. One example of such a text message 108 may comprise: “I am submitting a report of loitering and request an action to dispatch patrol car immediately”. In these examples, the controller 218, and/or the computing device 102 may determine one or more of the given public-safety or enterprise-safety incident type, the data documenting the given public-safety or enterprise-safety incident type, and the requested public-safety or enterprise-safety action associated with the given public-safety or enterprise-safety incident type by searching the text message 108, for example using terms from the records 122, such as text from the types 124, 134, the sets of documentation 126, 136 and/or the implementable public-safety or enterprise-safety actions 128, 138.

However, in other examples, the text message 108 may not explicitly recite one or more of the given public-safety or enterprise-safety incident type, the data documenting the given public-safety or enterprise-safety incident type, and the requested public-safety or enterprise-safety action associated with the given public-safety or enterprise-safety incident type. For example, the text message 108 does not explicitly use the terms “Loitering”, “Report” or “Dispatch Patrol Car Immediately”. In these examples the controller 218, and/or the computing device 102 may analyze the text message 108 using the context engine 148 (e.g., and/or the NLP engine) to determine one or more of: the given public-safety or enterprise-safety incident type; the data documenting the given public-safety or enterprise-safety incident type; and the requested public-safety or enterprise-safety action associated with the given public-safety or enterprise-safety incident type.

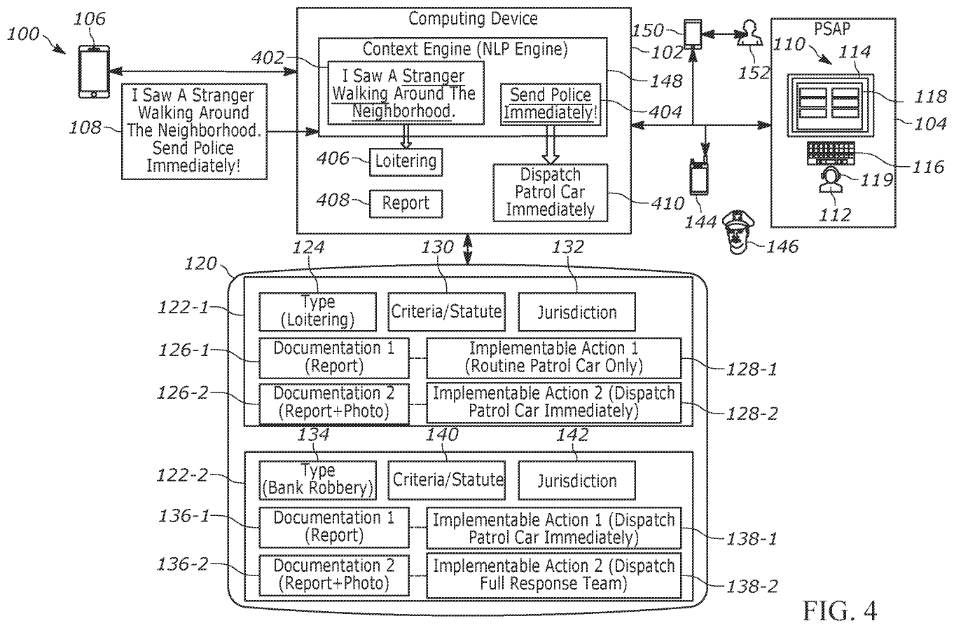

For example, the context engine 148 may receive the text message 108 as input, parse and/or separate the text of the text message 108 into phrases and/or sentences and/or groups of text and/or words, and analyze phrases and/or sentences and/or groups of text and/or words to determine one or more of: the given public-safety or enterprise-safety incident type; the data documenting the given public-safety or enterprise-safety incident type; and the requested public-safety or enterprise-safety action associated with the given public-safety or enterprise-safety incident type. An example of the context engine 148 analyzing the text message 108 of FIG. 1 is depicted in FIG. 4.

In yet further examples, the context engine 148 may be used regardless of a structure (or lack thereof) of the text message 108.

In yet further examples, the text message 108 may not include a requested public-safety or enterprise-safety action. An example of such a text message 108 may comprise: “I saw a stranger walking around the neighborhood” (e.g. or “I saw a stranger walking around the lobby of my office building”); in this example there is no requested public-safety or enterprise-safety action, and the text message 108 merely includes a report of loitering. In these examples, the controller 218 and/or the computing device 102 may be configured to determine that the requested public-safety or enterprise-safety action comprises a default requested public-safety or enterprise-safety action associated with one or more of the given public-safety or enterprise-safety incident type or a type of the text message 108.

For example, controller 218 and/or the computing device 102 may have access to a table and/or database (e.g., which may be a component and/or module of the application 222, and the like and/or may be stored at the memory 120, and the like) that associates given public-safety or enterprise-safety incident types with default actions. For example, a given public-safety or enterprise-safety incident type of “Loitering” may be associated with a default requested public-safety or enterprise-safety action of “Routine Patrol Car Only”, and a given public-safety or enterprise-safety incident type of “Bank Robbery” may be associated with a default requested public-safety or enterprise-safety action of “Dispatch Patrol Car Immediately”. While such examples are similar to the respective implementable public-safety or enterprise-safety actions 128-1, 138-1, in other examples the default requested public-safety or enterprise-safety action may be different from the respective implementable public-safety or enterprise-safety actions 128-1, 138-1. Hence, the controller 218 and/or the computing device 102 may be configured to determine that the requested public-safety or enterprise-safety action comprises a default requested public-safety or enterprise-safety action associated with the given public-safety or enterprise-safety incident type indicated by the text message 108 using such associations, however such a determination may occur in any suitable manner including, but not limited to, using one or more machine learning algorithms.

In other examples, controller 218 and/or the computing device 102 may have access to table and/or database (e.g., which may be a component and/or module of the application 222, and the like) that associates given types of text messages with default actions for given public-safety or enterprise-safety incident types. For example, an SMS-type text message generally does not have photos attached thereto; hence, a given public-safety or enterprise-safety incident type of “Loitering” as reported via an SMS message may be associated with a default requested public-safety or enterprise-safety action of “Routine Patrol Car Only”, and a given public-safety or enterprise-safety incident type of “Bank Robbery” as reported via an SMS message may be associated with a default requested public-safety or enterprise-safety action of “Dispatch Patrol Car Immediately”. However, an MMS-type text message generally includes multimedia, such as; hence, a given public-safety or enterprise-safety incident type of “Loitering” as reported via an MMS message may be associated with a default requested public-safety or enterprise-safety action of “Dispatch Patrol Control Car Immediately”, and a given public-safety or enterprise-safety incident type of “Bank Robbery” as reported via an MMS message may be associated with a default requested public-safety or enterprise-safety action of “Dispatch Full Response Team”. While such examples are similar to the respective implementable public-safety or enterprise-safety actions 128-2, 138-2, in other examples the default requested public-safety or enterprise-safety action may be different from the respective implementable public-safety or enterprise-safety actions 128-2, 138-2. Hence, the controller 218 and/or the computing device 102 may be configured to determine that the requested public-safety or enterprise-safety action comprises a default requested public-safety or enterprise-safety action associated with a type of the text message 108 using such associations, however such a determination may occur in any suitable manner including, but not limited to, using one or more machine learning algorithms.

At a block 304, the controller 218, and/or the computing device 102, determines an implementable public-safety or enterprise-safety action for the given public-safety or enterprise-safety incident type based on the data documenting the given public-safety or enterprise-safety incident type.

For example, the determining the implementable public-safety or enterprise-safety action for the given public-safety or enterprise-safety incident type based on the data documenting the given public-safety or enterprise-safety incident type may occur via one or more of: a database lookup; and one or more machine learning algorithms.

In particular, the controller 218, and/or the computing device 102 may use the given public-safety or enterprise-safety incident type and the data documenting the given public-safety or enterprise-safety incident type as indicated by the text message 108 to perform a database lookup for an implementable public-safety or enterprise-safety action at the memory 120. For example, with reference to FIG. 1, the given public-safety or enterprise-safety incident type may comprise “Loitering”, which corresponds to the type 124 “Loitering” of the record 122-1, and the data documenting the given public-safety or enterprise-safety incident type may comprise a “Report”, which corresponds to the documentation 126-1 of the record 122-1. As the implementable public-safety or enterprise-safety action 128-1 of “Routine Patrol Car Only” is associated with the documentation 126-1, the controller 218, and/or the computing device 102 may perform a database lookup of the record 122-1 and determine that an implementable public-safety or enterprise-safety action for the given public-safety or enterprise-safety incident type of “Loitering” (indicated by the text message 108), based on the data documenting the given public-safety or enterprise-safety incident type of a “Report” (indicated by the text message 108) comprises “Routine Patrol Car Only”. However such a determination may occur in any suitable manner including, but not limited to, using one or more machine learning algorithms.

Furthermore, it is understood that the implementable public-safety or enterprise-safety action determined at the block 304 may be based on one or more of statutory regulations and a protocol associated with a location of one or more of: the communication device 106; and the public-safety incident identified by the given public-safety or enterprise-safety incident type indicated by the text message 108.

For example, the text message 108 may be received with a location of the communication device 106 and/or a location of the public-safety incident identified by the given public-safety or enterprise-safety incident type. When both the location of the communication device 106 and the location of the public-safety incident are received, the controller 218, and/or the computing device 102 may default to using the location of the public-safety incident. Furthermore, it is understood that when database lookups of implementable public-safety or enterprise-safety actions occur, the location of the communication device 106 and/or a location of the public-safety incident may be compared to jurisdictions 132, 142 indicated in the records 122 to verify that the associated statute 130, 140 indicated by the records 122 apply to a received location. Alternatively, a database lookup may include using a received location in the database lookup. For example, there may be more than one record 122 stored at the memory 120 in association with a given public-safety or enterprise-safety incident type of “Loitering”, but for different jurisdictions. As such, a received location may be used to lookup a record 122 associated with a given public-safety or enterprise-safety incident type indicated by the text message 108, and that is also associated with jurisdiction that includes the received location.

At a block 306, the controller 218, and/or the computing device 102, determines whether there is a difference between the requested public-safety or enterprise-safety action (e.g., indicated by the text message 108) and the implementable public-safety or enterprise-safety action (e.g., determined at the block 304).

For example, determining the difference may occur by comparing the requested public-safety or enterprise-safety action, indicated by the text message 108, with the implementable public-safety or enterprise-safety action, determined at the block 304, to determine whether the requested public-safety or enterprise-safety action and the implementable public-safety or enterprise-safety action are the same, or different. Such a determination may occur via the aforementioned database lookup to determine the implementable public-safety or enterprise-safety action to compare to the requested public-safety or enterprise-safety action and/or via one or more machine learning algorithms, and/or in any other suitable manner (e.g., including, but not limited to, using programmatic algorithms).

Hence, in some examples, the method 300 may further comprise determining the difference between the requested public-safety or enterprise-safety action and the implementable public-safety or enterprise-safety action via one or more of: a database lookup of the implementable public-safety or enterprise-safety action based on the data; and one or more machine learning algorithms.

Furthermore, a determination of the requested public-safety or enterprise-safety action and the implementable public-safety or enterprise-safety action being the “same” may include the requested public-safety or enterprise-safety action and the implementable public-safety or enterprise-safety action having different wording, but having a same meaning, which may be determined via the context engine 148, one or more machine learning algorithms, and the like. For example, again referring to FIG. 1, a requested public-safety or enterprise-safety action indicated by the text message 108 is indicated by “Send Police Immediately”, which may have a same meaning as “Dispatch Patrol Car Immediately”, but using different text. However the context engine 148, one or more machine learning algorithms, and the like may be used to convert the text of “Send Police Immediately” to “Dispatch Patrol Car Immediately” for comparison with an implementable public-safety or enterprise-safety action determined at the block 304.

In response to determining a difference between the requested public-safety or enterprise-safety action and the implementable public-safety or enterprise-safety action (e.g., a “YES” decision at the block 306), at a block 308, the controller 218, and/or the computing device 102, generates a reply text message identifying one or more of the implementable public-safety or enterprise-safety action and the difference.

At a block 310 (e.g., also implemented in response to determining a difference between the requested public-safety or enterprise-safety action and the implementable public-safety or enterprise-safety action and/or a “YES” decision at the block 306), the controller 218, and/or the computing device 102, transmits (e.g., via the communication interface 202), to the communication device 106, the reply text message identifying one or more of the implementable public-safety or enterprise-safety action and the difference.

For example, the reply text message may include text indicating the implementable public-safety or enterprise-safety action, and/or text indicating that the requested public-safety or enterprise-safety action is different from the implementable public-safety or enterprise-safety action, and the like. Continuing with the example of FIG. 1, the requested public-safety or enterprise-safety action may comprise “Dispatch Patrol Car Immediately” and the implementable public-safety or enterprise-safety action may comprise “Routine Patrol Car Only”. As such there is a difference therebetween (e.g., as determined at the block 306), and a reply text message may comprise “We cannot send police immediately. We will send a routine patrol car only” and/or “We will send a routine patrol car only, which is different from the requested “Send police immediately”, and the like.

In some examples, the reply text message may identify the statute (e.g., the statute 130), which may cause the implementable public-safety or enterprise-safety action to be determined. Continuing with the example, of FIG. 1, a statute 130 that causes the implementable public-safety or enterprise-safety action 128-1 to be determined when only documentation 126-1 of a report is received may comprise a statutory regulation and/or law having a particular identifier, and the reply text message may identify the statutory regulation and/or law and/or the particular identifier. For example, a reply text message may comprise “We cannot send police immediately. We will send a routine patrol car only according to law 123ABC, which recites that we can only send a routine patrol only when only a report of loitering is received without a photo”.

However, in some examples the method 300 may further comprise the controller 218 and/or the computing device 102, determining further data required for implementing the requested public-safety or enterprise-safety action (e.g., indicated by the text message 108); and including, in the reply text message, an indication of the further data. Continuing with the example, of FIG. 1, for the requested public-safety or enterprise-safety action of “Send police immediately” and/or “Dispatch Patrol Car Immediately” to occur for loitering, according to the documentation 126-2 of the record 122-1, both a report and a photo should be received. Hence, in these examples, the further data required for implementing the requested public-safety or enterprise-safety action may be determined from the documentation 126-2 identified by the record 122-1, and may comprise a photo (e.g., of a suspect who is allegedly loitering). As such, a reply text message may comprise “We cannot send police immediately. We will send a routine patrol car. If you want us to send police immediately we require a photo of the suspect”.

In some of these examples, no reply from the communication device 106 may be received in response to the reply text message. However, in other examples, the method 300 may further comprise the controller 218 and/or the computing device 102, in response to the reply text message that includes the indication of the further data, receiving, from the communication device 106, the further data; and changing the implementable public-safety or enterprise-safety action to the requested public-safety or enterprise-safety action. Put another way, and again continuing with the example of FIG. 1, the communication device 106 may respond to the reply text message with a further text message (e.g., an MMS message) that includes a photo of the stranger indicated in the text message 108. As such, the controller 218 and/or the computing device 102 may again perform a database lookup to determine that the report received with the text message 108, and the photo received with the further text message meets the statute 130, which defines that the implementable public-safety or enterprise-safety action 128-2 of “Dispatch Control Car Immediately” may occur when a report and a photo are received as defined by the documentation 126-2. As such, the implementable public-safety or enterprise-safety action 128-1 determined at the block 304 may be changed to the requested public-safety or enterprise-safety action, which is the same as the implementable public-safety or enterprise-safety action 128-2.

Returning to the block 306, in response to determining that the requested public-safety or enterprise-safety action and the implementable public-safety or enterprise-safety action are the same and/or determining that there is not a difference between the requested public-safety or enterprise-safety action and the implementable public-safety or enterprise-safety action (e.g., a “NO” decision at the block 306), at a block 312, the controller 218, and/or the computing device 102, generates a different reply text message indicating that the requested public-safety or enterprise-safety action is to be implemented.

At a block 314 (e.g., also implemented in response to determining that the requested public-safety or enterprise-safety action and the implementable public-safety or enterprise-safety action are the same and/or determining that there is not a difference between the requested public-safety or enterprise-safety action and the implementable public-safety or enterprise-safety action and/or a “NO” decision at the block 306), the controller 218, and/or the computing device 102, transmits (e.g., via the communication interface 202), to the communication device 106, the different reply text message indicating that the requested public-safety or enterprise-safety action is to be implemented.

Continuing with the example of FIG. 1, the text message 108 may include a photo such that at the block 304 the implementable public-safety or enterprise-safety action 128-2 is determined, which may be the same as the requested public-safety or enterprise-safety action. In these example, the reply text message may comprise “We are sending police immediately”, and the like.

In some examples, the method 300 may further comprise the controller 218 and/or the computing device 102 causing the implementable public-safety or enterprise-safety action (e.g., determined at the block 304 and/or as changed to the requested public-safety or enterprise-safety action) to occur by dispatching public-safety personnel or enterprise-safety personnel to a location of one or more of: the communication device 106; and a public-safety incident identified by the given public-safety or enterprise-safety incident type indicated by the text message 108.

For example, the controller 218 and/or the computing device 102 may transmit a message to the radio 144 that includes the location of the communication device 106 and/or the public-safety incident and instructions that the public-safety officer 146 is to implement the implementable public-safety or enterprise-safety action, for example on a routine patrol (or immediately). Alternatively, the controller 218 and/or the computing device 102 may transmit a similar message to the PSAP 104 and/or the PSAP terminal 110 so that the operator 112 may review the message (e.g., via the interface 118 at the display screen 114) and communicate (e.g., using the headset 119) with the public-safety officer 146 via the radio 144 to instruct the public-safety officer 146 to implement the implementable public-safety or enterprise-safety action. In some examples, a review of the implementable public-safety or enterprise-safety action may be required at the PSAP 104 (e.g., by the operator 112) prior to causing the implementable public-safety or enterprise-safety action being implemented; for example, when the given public-safety or enterprise-safety incident type is a “Bank Robbery” and a report and photo are received that correspond to the documentation 136-2, prior to the implementable public-safety or enterprise-safety action 138-2 of “Dispatch Full Response Team” occurring, the operator 112 may review the implementable public-safety or enterprise-safety action 138-2, the report and the photo, amongst other possibilities, before dispatching a full response team, for example to prevent swatting incidents, and the like.

In yet further examples, when there is a difference between the requested public-safety or enterprise-safety action and a default response associated with first public-safety or enterprise-safety personnel and/or a first public-safety or enterprise-safety agency (e.g. a police agency), for example as determined at the block 306, but second public-safety or enterprise-safety personnel and/or a second public-safety or enterprise-safety agency has the capability and/or resources to respond to the public-safety or enterprise-safety incident and/or at least partially provide the requested public-safety or enterprise-safety action, contact information of the second public-safety or enterprise-safety personnel and/or the second public-safety or enterprise-safety agency may be provided to the communication device 106 (e.g. in the reply text message generated and transmitted at the block 308 and the block 310) and/or the second public-safety or enterprise-safety personnel and/or the second public-safety or enterprise-safety agency may be caused to implement the requested action, with the reply text message generated and transmitted at the block 308 and the block 310 adapted accordingly.

In a specific example, when the requested public-safety or enterprise-safety action comprises “Dispatch Patrol Car Immediately”, and a default response comprises “Routine Patrol Car Only”, but the enterprise-safety officer 152, such as a mental-health professional associated with a mental-wellness agency, is available for immediate dispatch, the reply text message of the blocks 308, 310 may be adapted to include contact information of the enterprise-safety officer 152, such as the phone number associated with the communication device 150, and/or the enterprise-safety officer 152 may be dispatched to the incident, with the reply text message of the blocks 308, 310 adapted accordingly. Hence, while the enterprise-safety officer 146 is not dispatched (e.g. “Dispatch Patrol Car Immediately” does not occur), as the enterprise-safety officer 152 is available, and as dispatch of the enterprise-safety officer 152 may provide less of a strain on public-safety resources, the enterprise-safety officer 152 may be dispatched. Such alternative actions may be stored at the memory 120 and/or records 122 in association with the incident types 124, along with the contact information of the enterprise-safety officer 152, and the like.

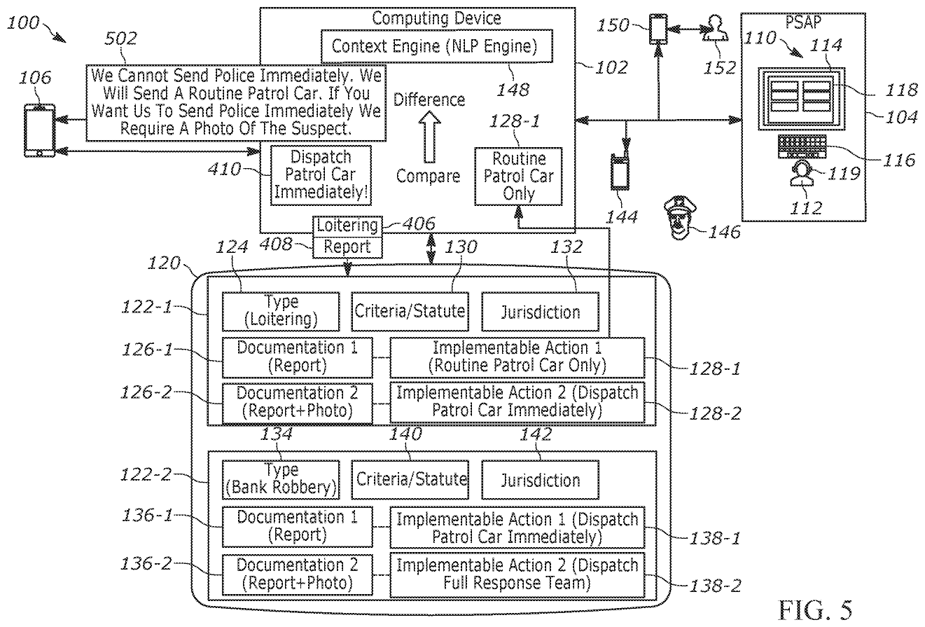

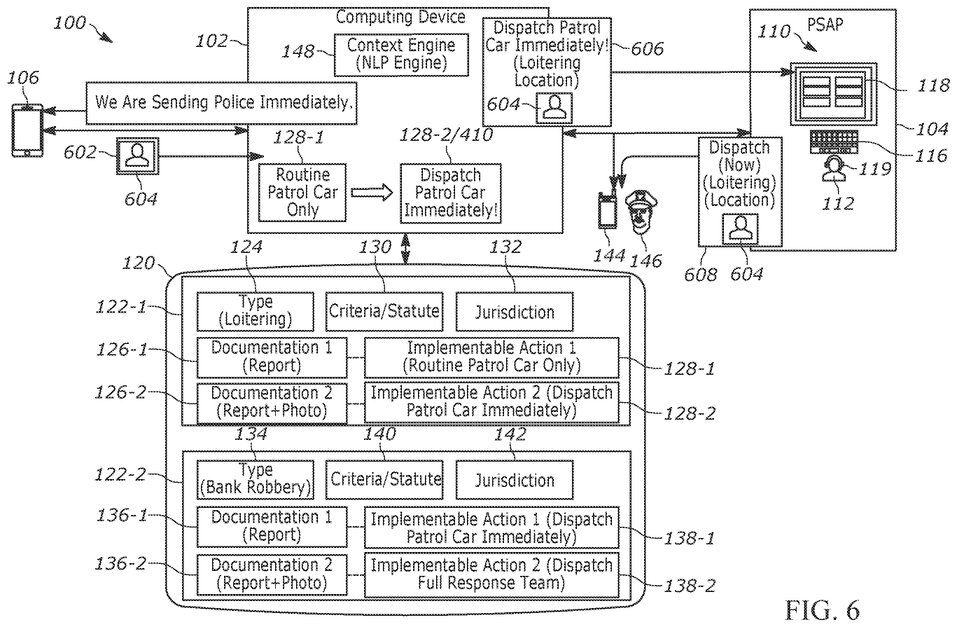

Attention is next directed to FIG. 4, FIG. 5, and FIG. 6, which depict examples of the method 300. FIG. 4, FIG. 5, and FIG. 6 are substantially similar to FIG. 1, with like components having like numbers.

Attention is first directed to FIG. 4, which depicts the computing device 102 receiving (e.g., at the block 302 of the method 300) the text message 108.

FIG. 4 further depicts the text message 108 being input to the context engine 148, which separates the text of the text message 108 into sentences 402, 404 and identifies keywords in the sentences 402, 404, which may be used to identify a given public-safety or enterprise-safety incident type, data documenting the given public-safety or enterprise-safety incident type, and a requested public-safety or enterprise-safety action associated with the given public-safety or enterprise-safety incident type.

For example as depicted in FIG. 4, the words “stranger”, “walking” and “neighborhood” have been identified by the context engine 148 as keywords associated with a given public-safety or enterprise-safety incident type 406 of “Loitering”. Furthermore, the sentence 402 has been identified by the context engine 148 as comprising data 408 of a “Report” documenting the “Loitering”. Furthermore, the words “send”, “police” (and/or “send police”) and “immediately” have been identified by the context engine 148 as keywords associated with a requested public-safety or enterprise-safety action 410 of “Dispatch Patrol Car Immediately”.

Attention is next directed to FIG. 5, which depicts the computing device 102 determining (e.g., at the block 304 of the method 300) an implementable public-safety or enterprise-safety action for the given public-safety or enterprise-safety incident type 406 based on the data 408, for example by performing a database lookup of the records 122 using the given public-safety or enterprise-safety incident type 406 and the data 408. As depicted, the given public-safety or enterprise-safety incident type 406 of “Loitering” is understood to identify the record 122-1, as the given public-safety or enterprise-safety incident type 406 of “Loitering” matches the given public-safety or enterprise-safety incident type 124 of the record 122-1. Similarly, the data 408 of a “Report” is understood to correspond with the documentation 126-1, which is associated with the implementable public-safety or enterprise-safety action 128-1 of “Routine Patrol Car Immediately”, which is retrieved from the record 122-1 by the computing device 102.

As depicted in FIG. 5, the computing device 102 compares the requested public-safety or enterprise-safety action 410 of “Dispatch Patrol Car Immediately” with the implementable public-safety or enterprise-safety action 128-1 of “Routine Patrol Car Immediately” to determine that there is a difference therebetween (e.g., a “YES” decision at the block 306 of the method 300).

As such, the computing device 102 generates (e.g., at the block 308 of the method 300) a reply text message 502 of “We cannot send police immediately. We will send a routine patrol car. If you want us to send police immediately we require a photo of the suspect.” The computing device 102 furthermore transmits the reply text message 502 to the communication device 106, for example as a response to the text message 108.

In this example the reply text message 502 identifies further data of a “photo of the suspect” require to implement the requested public-safety or enterprise-safety action 410, which may be determined by comparing the requested public-safety or enterprise-safety action 410 of “Dispatch Patrol Car Immediately” with the implementable public-safety or enterprise-safety action 128-2 to determine the associated documentation 126-2.

In some examples (not depicted), the reply text message 502 may include a phone number of the communication device 150. For example, the reply text message 502 may comprise: “We cannot send police immediately. We will send a routine patrol car. If you want us to send police immediately we require a photo of the suspect. If the suspect appears to be experiencing a mental health crisis, please call 312-555-1212, the local mental health crisis line”, where “312-555-1212” is understood to comprise a phone number of the communication device 150 and/or a phone number associated with a mental-wellness agency.

Attention is next directed to FIG. 6, which depicts the communication device 106 responding to the reply text message 502 with a further text message 602 that includes a photo 604 of the stranger referred to in the text message 108. As such, the computing device 102 may determine that the documentation 126-2 has been received and change the implementable public-safety or enterprise-safety action 128-1 to the implementable public-safety or enterprise-safety action 128-2 and/or the requested public-safety or enterprise-safety action 410 of “Dispatch Patrol Car Immediately” (e.g., which is the same as the implementable public-safety or enterprise-safety action 128-2).

The computing device 102 may cause the implementable public-safety or enterprise-safety action 128-2 and/or the requested public-safety or enterprise-safety action 410 to occur by generating and transmitting to the PSAP 104 a message 606, which includes a command to “Dispatch Patrol Car Immediately”, as well as a “Location” received with the text message 108 (e.g., the location of the communication device 106 and/or the public-safety incident reported by the text message 108), an indication, “Loitering” of the given public-safety type that is to be investigated, and the photo 604.

The message 606 may be received at the PSAP terminal 110 and may be provided at the interface 118 provided at the display screen 114 for review by the operator 112. The operator 112 may operate the PSAP terminal 110 to transmit a dispatch command 608 to the radio 144 to dispatch a patrol car operated by the public-safety officer 146 to the “Location” received with the text message 108. As such the dispatch command 608 may comprise a command of “Dispatch” to a “Location” to investigate “Loitering” at a time of “Now”, along with the photo 604. Indeed, the dispatch command 608 may be populated with information from the message 606.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a computing device, from a communication device, a text message indicative of: a given public-safety or enterprise-safety incident type; data documenting the given public-safety or enterprise-safety incident type; and a requested public-safety or enterprise-safety action associated with the given public-safety or enterprise-safety incident type;
determining, at the computing device, an implementable public-safety or enterprise-safety action for the given public-safety or enterprise-safety incident type based on the data; and
in response to determining, at the computing device, a difference between the requested public-safety or enterprise-safety action and the implementable public-safety or enterprise-safety action:
generating, at the computing device, a reply text message identifying one or more of the implementable public-safety or enterprise-safety action and the difference; and
transmitting, from the computing device, to the communication device, the reply text message.

2. The method of claim 1, further comprising:
determining further data required for implementing the requested public-safety or enterprise-safety action; and
including, in the reply text message, an indication of the further data.

3. The method of claim 2, further comprising:
in response to the reply text message that includes the indication of the further data, receiving, from the communication device, the further data; and
changing the implementable public-safety or enterprise-safety action to the requested public-safety or enterprise-safety action.

4. The method of claim 1, further comprising:
in response to determining that the requested public-safety or enterprise-safety action and the implementable public-safety or enterprise-safety action are the same:
generating, at the computing device, a different reply text message indicating that the requested public-safety or enterprise-safety action is to be implemented; and
transmitting, from the computing device, to the communication device, the different reply text message.

5. The method of claim 1, further comprising:
analyzing the text message using one or more of a context engine and a natural language processing engine to determine one or more of: the given public-safety or enterprise-safety incident type; the data documenting the given public-safety or enterprise-safety incident type; and the requested public-safety or enterprise-safety action associated with the given public-safety or enterprise-safety incident type.

6. The method of claim 1, wherein the data comprises one or more of:
text of the text message; and
attachments to the text message.

7. The method of claim 1, wherein determining the implementable public-safety or enterprise-safety action for the given public-safety or enterprise-safety incident type based on the data occurs via one or more of:
a database lookup; and
one or more machine learning algorithms.

8. The method of claim 1, wherein the implementable public-safety or enterprise-safety action is based on one or more of statutory regulations and a protocol associated with a location of one or more of: the communication device; and a public-safety incident identified by the given public-safety or enterprise-safety incident type indicated by the text message.

9. The method of claim 1, further comprising determining the difference between the requested public-safety or enterprise-safety action and the implementable public-safety or enterprise-safety action via one or more of:
a database lookup of the implementable public-safety or enterprise-safety action based on the data; and
one or more machine learning algorithms.

10. The method of claim 1, further comprising causing the implementable public-safety or enterprise-safety action to occur by dispatching public-safety or enterprise-safety personnel to a location of one or more of:
the communication device; and
a public-safety incident identified by the given public-safety or enterprise-safety incident type indicated by the text message.

11. The method of claim 1, wherein the requested public-safety or enterprise-safety action comprises a default requested public-safety or enterprise-safety action associated with one or more of the given public-safety or enterprise-safety incident type or a type of the text message.

12. A device comprising:
a communication interface; and
a controller configured to:
receive, via the communication interface, from a communication device, a text message indicative of: a given public-safety or enterprise-safety incident type; data documenting the given public-safety or enterprise-safety incident type; and a requested public-safety or enterprise-safety action associated with the given public-safety or enterprise-safety incident type;
determine an implementable public-safety or enterprise-safety action for the given public-safety or enterprise-safety incident type based on the data; and
in response to determining a difference between the requested public-safety or enterprise-safety action and the implementable public-safety or enterprise-safety action:
generate a reply text message identifying one or more of the implementable public-safety or enterprise-safety action and the difference; and
transmit, via the communication interface, to the communication device, the reply text message.

13. The device of claim 12, wherein the controller is further configured to:
determine further data required for implementing the requested public-safety or enterprise-safety action;
include, in the reply text message, an indication of the further data; and
in response to the reply text message that includes the indication of the further data, receive, via the communication interface, from the communication device, the further data; and
change the implementable public-safety or enterprise-safety action to the requested public-safety or enterprise-safety action.

14. The device of claim 12, wherein the controller is further configured to:
in response to determining that the requested public-safety or enterprise-safety action and the implementable public-safety or enterprise-safety action are the same:
generate a different reply text message indicating that the requested public-safety or enterprise-safety action is to be implemented; and
transmit, via the communication interface, to the communication device, the different reply text message.

15. The device of claim 12, wherein the controller is further configured to:
analyze the text message using one or more of a context engine and a natural language processing engine to determine one or more of: the given public-safety or enterprise-safety incident type; the data documenting the given public-safety or enterprise-safety incident type; and the requested public-safety or enterprise-safety action associated with the given public-safety or enterprise-safety incident type.

16. The device of claim 12, wherein the data comprises one or more of:
text of the text message; and
attachments to the text message.

17. The device of claim 12, wherein the controller is further configured to determine the implementable public-safety or enterprise-safety action for the given public-safety or enterprise-safety incident type based on the data via one or more of:
a database lookup; and
one or more machine learning algorithms.

18. The device of claim 12, wherein the implementable public-safety or enterprise-safety action is based on one or more of statutory regulations and a protocol associated with a location of one or more of: the communication device; and
a public-safety incident identified by the given public-safety or enterprise-safety incident type indicated by the text message.

19. The device of claim 12, wherein the controller is further configured to cause the implementable public-safety or enterprise-safety action to occur by dispatching public-safety or enterprise-safety personnel to a location of one or more of:
the communication device; and
a public-safety incident identified by the given public-safety or enterprise-safety incident type indicated by the text message.

20. The device of claim 12, wherein the requested public-safety or enterprise-safety action comprises a default requested public-safety or enterprise-safety action associated with one or more of the given public-safety or enterprise-safety incident type or a type of the text message.
